(19) United States
(12) Patent Application Publication
(10) Pub. No.: US 2017/0109026 A1
(43) Pub. Date: Apr. 20, 2017

(54) DIAL CONTROL FOR TOUCH SCREEN NAVIGATION

(71) Applicant: HEWLETT PACKARD ENTERPRISE DEVELOPMENT LP, Houston, TX (US)

(72) Inventors: David Ismailov, Yehud (IL); Reuven Yamrom, Yehud (IL); Eynat Pikman, Yehud (IL)

(21) Appl. No.: 14/884,903

(22) Filed: Oct. 16, 2015

(51) Int. Cl. G06F 3/0484; G06F 3/0482; G06F 3/0488

(52) U.S. Cl. CPC G06F 3/04847; G06F 3/04883; G06F 3/04845; G06F 3/04842; G06F 3/0482; G06F 3/04886; G06F 2203/04104

(57) ABSTRACT

A computing device includes a hardware processor and a machine-readable storage medium storing instructions. The instructions may be executable to: display, on a touch screen, a first screen image of a user interface of the computing device; detect a first touch gesture on the first screen image, where the first touch gesture is associated with a dial control including a plurality of control options; and in response to a detection of the first touch gesture: blur the first screen image; present the dial control over the first screen image; in response to a rotation of the first touch gesture, rotate the dial control to select a first control option of the plurality of control options; and in response to a selection of the first control option, present additional information in a second portion of the touch screen.

### BACKGROUND

Some electronic devices include touch screens. A touch screen may provide a visual display. Further, a touch screen may receive touch input indicating user commands. For example, a user may touch the touch screen to adjust the size of the displayed contents.

### BRIEF DESCRIPTION OF THE DRAWINGS

Some implementations are described with respect to the following figures.

FIG. 1 is a schematic diagram of an example computing device, in accordance with some implementations.

FIG. 2 is a schematic diagram of an example network, in accordance with some implementations.

FIGS. 3A-3D are illustrations of a touch screen according to an example implementation.

FIG. 4 is a flow diagram of an example process in accordance with some implementations.

FIG. 5 is a diagram of an example machine-readable storage medium storing instructions in accordance with some implementations.

FIG. 6 is a schematic diagram of an example computing device, in accordance with some implementations.

### DETAILED DESCRIPTION

Touch screens may be used in electronic devices such as tablet computers, laptop computers, desktop computer, smart phones, gaming devices, and so forth. A touch screen may be used to interact with menu options or controls presented on the user interface. However, in some devices, such user interfaces can be confusing and obtrusive. For example, in a device having a large number of commands or options, the menu bar can cluttered, and can occupy a large proportion of the available display space of the touch screen.

In accordance with some implementations, techniques or mechanisms are provided for a dial control for interacting with a user interface on a touch screen. The dial control is a graphical control element that can be invoked by a touch gesture. In some implementations, when the dial control appears, any previous image shown on the screen is blurred or obscured. The dial control may include multiple options that are selected by turning the touch gesture. A selection feature may indicate the option that is currently selected. As each option enters or is proximate to the selection feature, information related to that option is shown next to the dial control. In some implementations, when the user releases the touch gesture, the user interface may perform a navigation action based on an option that is currently selected in the dial control.

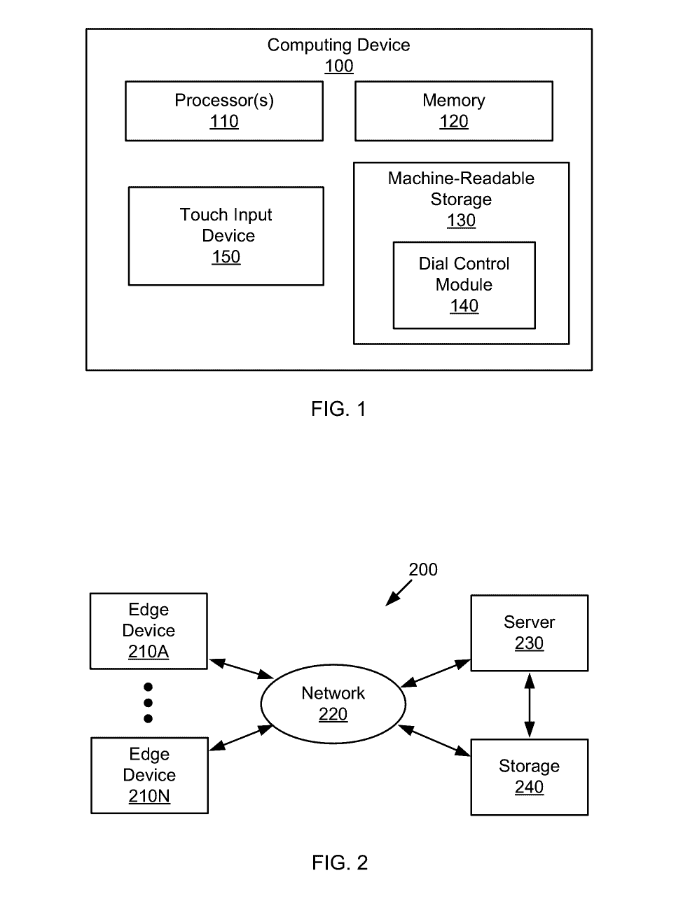

FIG. 1 shows a schematic diagram of an example computing device 100, in accordance with some implementations. As shown, in some implementations, the computing device 100 may include processor(s) 110, memory 120, a touch screen device 150, and machine-readable storage 130.

In some implementations, the touch screen device 150 may include a touch-sensitive display, a touch-sensitive pad mounted in proximity to a screen, a touch peripheral connected to the computing device 100 by a cable, and so forth. The processor(s) 110 can include a microprocessor, microcontroller, processor module or subsystem, programmable integrated circuit, programmable gate array, multiple processors, a microprocessor including multiple processing cores, or another control or computing device. The memory 120 can be any type of computer memory (e.g., dynamic random access memory (DRAM), static random-access memory (SRAM), etc.). The machine-readable storage 130 can include non-transitory storage media such as hard drives, flash storage, optical disks, etc.

As shown in FIG. 1, the dial control module 140 may be implemented as instructions stored in the machine-readable storage 130. However, the dial control module 140 can be implemented in any suitable manner. For example, the features of the dial control module 140 can also be implemented in any combination of software, firmware, and/or hardware (e.g., circuitry).

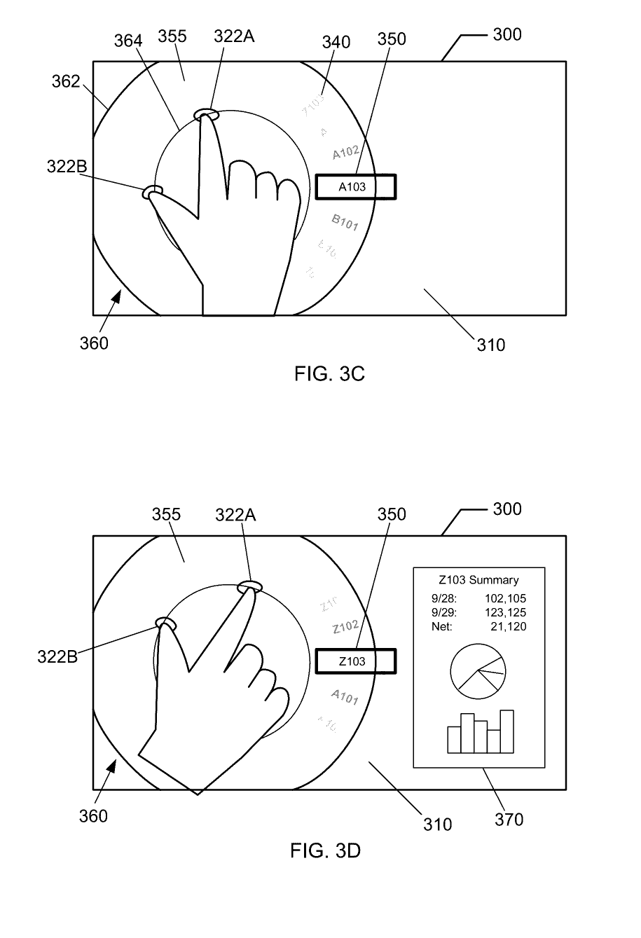

In some implementations, the dial control module 140 can detect a touch gesture associated with a dial control. For example, the dial control module 140 may detect that a user is touching multiple locations on the touch screen device 150 (referred to herein as “touch points”), and may determine that the pattern of these touch points matches a predefined touch gesture that is reserved for use with dial controls. In response to this determination, the dial control module 140 may invoke or cause a display of a dial control on the touch screen device 150. Further, the dial control module 140 may perform control actions in response to user inputs provided via the dial control. Features of the dial control and/or the dial control module 140 are discussed further below with reference to FIGS. 3A-6.

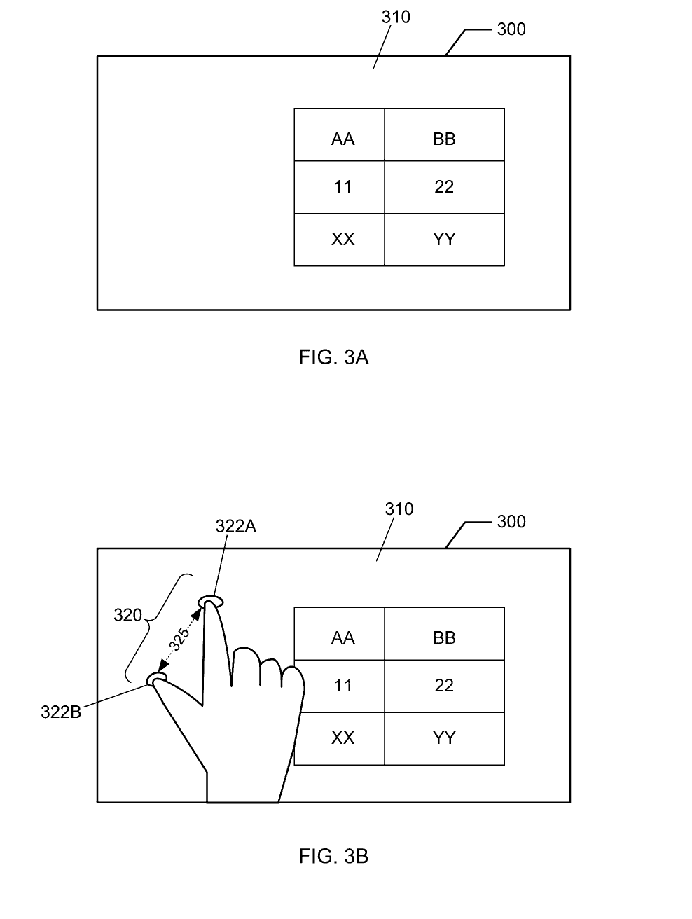

Referring now to FIG. 2, shown is an example system 200, in accordance with some implementations. As shown, the system 200 may include a network 220 connecting any number of computing devices, such as a server 230, a storage device 240, and edge devices 210A-210N. In some implementations, any of the computing devices included in system 200 may include the components of the computing device 100 shown in FIG. 1. For example, any of the edge devices 210A-210N may include a touch screen device 150 and/or the dial control module 140 shown in FIG. 1.

Referring now to FIGS. 3A-3B, shown are illustrations of a touch screen 300 at different points in time during a touch gesture, in accordance with some implementations. The touch screen 300 may correspond generally to the touch screen device 150 shown in FIG. 1.

FIG. 3A illustrates the touch screen 300 at a first point in time, namely prior to receiving a touch gesture. As shown, the touch screen 300 may display a screen image 310. For example, the screen image 310 may be a user interface screen displayed to a user of the computing device 100 (shown in FIG. 1).

Referring now to FIG. 3B, shown is the touch screen 300 at a second point in time. Specifically, FIG. 3B shows an example of a user performing a touch gesture 320 on the touch screen 300 to invoke a dial control. As shown, in some implementations, the touch gesture 320 includes touching the user interface 300 at a first touch point 322B and a second touch point 322B (referred to collectively as “touch points 322”). The touch gesture 320 may be recognized by a controller or logic of a computing device (e.g., the dial control module 140 shown in FIG. 1).

In some implementations, the touch gesture 320 may include only the first touch point 322B and the second touch point 322B separated by a fixed distance 325, and may be limited by defined time and/or distance thresholds. For example, the touch gesture 320 may not be recognized if the user is touching the touch screen 300 at a third location. In another example, the touch gesture 320 may not be recognized if the distance 325 is not maintained for at least a minimum time period. In still another example, the touch gesture 320 may not be recognized if the distance 325 changes by more than a defined amount. In further examples, the touch gesture 320 may not be recognized if the distance 325 is less than a minimum distance, is greater than a maximum distance, and/or is not maintained between the minimum and maximum distances for at least a given time period.

In some implementations, the touch gesture 320 may not result in any interaction with an underlying screen image/interface. For example, the touch gesture 320 may be performed on any portion of the touch screen 300 without interacting with (e.g., providing input to, controlling, etc.) any elements of the screen image 310.

Referring now to FIG. 3C, shown is the touch screen 300 at a third point in time. Specifically, FIG. 3C illustrates an example dial control 360 that has been invoked by the touch gesture 320 (shown in FIG. 3B). In some implementations, the dial control 360 may be displayed only after the touch gesture 320 is maintained continuously for at least a minimum time period. The dial control 360 may be generated by the dial control module 140 (shown in FIG. 1).

In some implementations, when the dial control 360 is invoked, the previously-displayed contents of the touch screen 150 may be modified. In some implementations, such modification may reduce the visibility of the previously-displayed contents, and may include blurring, dimming, obscuring, increasing transparency, and so forth. For example, as shown in FIG. 3C, invoking the dial control 360 causes the previous screen image 310 to be blurred. Further, the dial control 360 may be superimposed over a portion of the blurred screen image 310.

As shown in FIG. 3C, the dial control 360 may include a circular portion 355 having an outer circumference 362. In some implementations, the circular portion 355 can be rotated around a central point. Such rotation may be caused by a rotation motion of the touch gesture 320. For example, the user may cause a rotation of the circular portion 355 by rotating the touch gesture 320.

In some implementations, the circular portion 355 may have an inner circumference 364. Further, in some implementations, the inner circumference 364 may be defined by the touch points 322. For example, as shown in FIG. 3C, the inner circumference 364 may pass through or intersect each of the touch points 322. In another example, the inner circumference 364 may be placed at a specified distance from each of the touch points 322. In some implementations, the outer circumference 362 may be defined based on the inner circumference 364 and/or the touch points 322. For example, the outer circumference 362 may concentric with the inner circumference 364, and may be placed at a defined distance from with the inner circumference 364. Further, in some implementations, the inner circumference 364 and/or the outer circumference 362 may be based on other parameter(s) (e.g., size of the touch screen 300, font settings, user preference settings, content of the screen image 310, etc.).

As shown, the dial control 360 may include a number of control options 340. As used herein, the term “control option” refers to a graphical or text indication representing a unique control command, action, or input. For example, the control options 340 may include text labels, symbols, and/or pictures. In some implementations, the control options 340 may be disposed at different radial locations around the circular portion 355. Further, in some implementations, the control options 340 are disposed outside a circumference defined by the touch gesture 320 (e.g., the inner circumference 364). The control options 340 included in the dial control 360 may be based on any parameters, settings, and/or content (e.g., available commands or menus, user preferences, default settings, security permissions, user or group access permissions, content of the screen image 310, program code, etc.).

In some implementations, the dial control 360 may include a selector element 350 to indicate the selection of one of the control options 340. For example, as shown in FIG. 3C, the selector element 350 may be box or area that surrounds a control option 340 (labeled “A103”), thereby indicating that this control option 340 is currently selected in the dial control 360. In other implementations, the selector element 350 may indicate the selected control option 340 by any other technique (e.g., an arrow, a line, highlighting, proximity to an indicator, etc.)

In some implementations, the selector element 350 does not rotate in response to a rotation motion of the touch gesture 320. Thus, when the circular portion 355 is rotated by the user, the selector element 350 remains stationary. As such, the control options 340 disposed around the circular portion 355 are rotated through the selector element 350. In this manner, the user may control which control option 340 is currently selected by adjusting the amount of rotation of the touch gesture 320.

In some implementations, the visibility of the control options 340 may be varied based on their respective distance from the selector element 350. For example, as shown in FIG. 3C, the control options 340 may be increasingly blurred or dimmed as they become more distant from the selector element 350. In this manner, the focus of the user may be drawn to those control options 340 that proximate to the selector element 350.

Referring now to FIG. 3D, shown is the touch screen 300 at a fourth point in time. Specifically, FIG. 3D illustrates an example in which the user has rotated the touch gesture 320 by a given angle, and has thereby caused the dial control 360 to rotate by the same angle. Thus, as shown, the selector element 350 now indicates that a different control option 340 (labeled “Z103”) is currently selected.

In some implementations, changing the selection in the selector element 350 causes an information display area 370 to be displayed or updated on the touch screen 300. Further, the information display area 370 may display information related to the selected control option 340. For example, assume that the label “Z103” identifies a particular subject or topic of information (e.g., financial reports for an organization named “Z103”). Thus, referring to FIG. 3D, rotating the control option 340 labeled “Z103” into the selector element 350 may cause the information display area 370 to automatically display financial information for the organization “Z103.” In some implementations, the information display area 370 may display a preview or summary of information included in a different location or interface screen.

In some implementations, the information display area 370 may be separate from the dial control 360. For example, the dial control 360 may be included in a first portion of the touch screen 300, and the information display area 370 may be included in a second portion of the touch screen 300. Further, in some implementations, the information display area 370 may not be selectable by a touch input, and/or may not be used to perform or trigger actions in the user interface.

In some implementations, when a user rotates the touch gesture 320, the information display area 370 may be automatically updated as each control option 340 is rotated through (or in proximity to) the selector element 350. Further, such updating may be continued while the user maintains the touch gesture 320. In this manner, the user can obtain information associated with multiple control options 340 by rotating a single touch gesture 320.

In some implementations, a user may perform or provide a triggering input for the dial control 360 to perform a navigation action. The navigation action may cause the touch screen 300 to display a new interface screen. For example, in some implementations, the navigation action may include displaying a particular web page, a menu, a program interface, a video display, and so forth. In some implementations, the triggering input may include “releasing” the touch gesture 320 (e.g., moving the fingers directly away from the touch screen 300). Further, in some implementations, the triggering input may include tapping the touch screen 300, a voice command, and so forth.

In some implementations, the triggering input triggers a navigation action that is associated with the currently selected control option 340 (e.g., the control option 340 indicated by the selector element 350). For example, as shown in FIG. 3D, the user has rotated the touch gesture 320 to select the control option 340 labeled “Z103.” Assume that the information display area 370 is then automatically updated to display a summary or a preview of a financial report for organization “Z103.” Note that the information display area 370 is updated without the dial control 360 being triggered.

Assume further that the user releases the touch gesture 320 while the “Z103” control option 340 remains selected, and thus triggers the dial control 360 to perform a navigation action, namely to display the full financial report for organization “Z103.” In some implementations, performing a navigation action may include dismissing or removing the dial control 360 from display in the touch screen 300.

In some implementations, the dial control 360 may be maintained or persisted on the touch screen 300 for a specified time period (e.g., 0.5 seconds, 1 second, 2 seconds, etc.) after the user has triggered a navigation action. Further, in some implementations, the dial control 360 may indicate that a navigation action has been triggered by a visual or auditory signal (e.g., a flash, a blink, a sound, etc.). Such features may enable the user to verify that the intended control option 340 was selected.

In some implementations, the user may perform an action to dismiss the dial control 360 without triggering a navigation action. For example, in some implementations, the user may dismiss the dial control 360 by performing a pinching motion of the first touch point 322A and the second touch point 322B.

Note that, while FIGS. 1-3D illustrate various examples, other implementations are also possible. For example, it is contemplated that the dial control 360 may have other configurations or presentations. Further, the circular portion 355 may be a disc without an inner circumference. In another example, the control options 340 may be arranged or oriented in any manner. In still another example, the touch gesture 320 may include any number of touch points, may have a different arrangement or pattern of touch points, may include motions, and so forth. In yet another example addition, the selector element 350 may have any shape or configuration. Furthermore, the touch gesture 320, the dial control 360, and/or the information display area 370 may be located in any portion of the touch screen 300, and may be arranged or positioned in any manner relative to each other. Any of the features described above with reference to FIGS. 1-3D may combined and/or used with any other features described herein. Other combinations and/or variations are also possible.

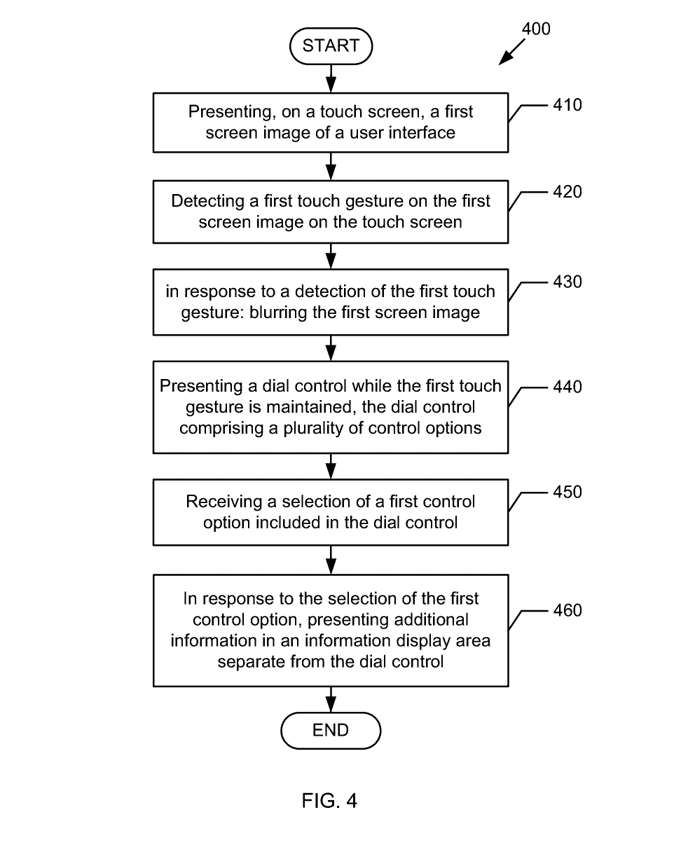

Referring now to FIG. 4, shown is a process 400 for presenting a dial control, in accordance with some implementations. The process 400 may be performed by the processor(s) 110 and/or the dial control module 140 shown in FIG. 1. The process 400 may be implemented in hardware (e.g., circuitry) or machine-readable instructions (e.g., software and/or firmware). The machine-readable instructions are stored in a non-transitory computer readable medium, such as an optical, semiconductor, or magnetic storage device. For the sake of illustration, details of the process 400 may be described below with reference to FIGS. 1-3D, which show examples in accordance with some implementations. However, other implementations are also possible.

At block 410, a first screen image may be presented on a touch screen of a computing device. For example, referring to FIG. 3A, the screen image 310 is displayed on the touch screen 300.

At block 420, a first touch gesture may be detected on the screen image on the touch screen. For example, referring to FIGS. 1 and 3B, the dial control module 140 may detect the touch gesture 320 on the screen image 310. In some implementations, the touch gesture 320 may be reserved for invoking the dial control 360, and may include a defined pattern of touch points 322 on a touch screen 300.

At block 430, the first screen image may be blurred in response to a detection of the first touch gesture. For example, referring to FIGS. 1 and 3C, the dial control module 140 can blur the screen image 310 in response to detecting the touch gesture 320 on the touch screen 300.

At block 440, a dial control may be presented while the first touch gesture is maintained. In some implementations, the dial control may include a plurality of control options. Further, in some implementations, the plurality of control options may be included in a rotating portion of the dial control. The dial control may also include a selector portion. For example, referring to FIGS. 1 and 3C, the dial control module 140 can present the dial control 360 in response to detecting the touch gesture 320. The dial control 360 can include multiple control options 340, each corresponding to a unique navigation action or command.

At block 450, a selection of a first control option included in the dial control may be received. For example, referring to FIGS. 1 and 3D, the dial control module 140 may detect that the user has rotated the touch gesture 320 by an angle, and thus causes the rotating circular portion 355 of the dial control 360 to rotate by the same angle. The control option 340 labeled “Z103” is surrounded by the selector element 350, thus indicating that the control option 340 labeled “Z103” is selected in the dial control 360.

At block 460, in response to the selection of the first control option, additional information may be presented in an information display area that is separate from the dial control. For example, referring to FIGS. 1 and 3D, the dial control module 140 may detect that the control option 340 labeled “Z103” is currently selected, and may cause the information display area 370 to display information related to the organization “Z103.” After block 460, the sequence 400 is completed.

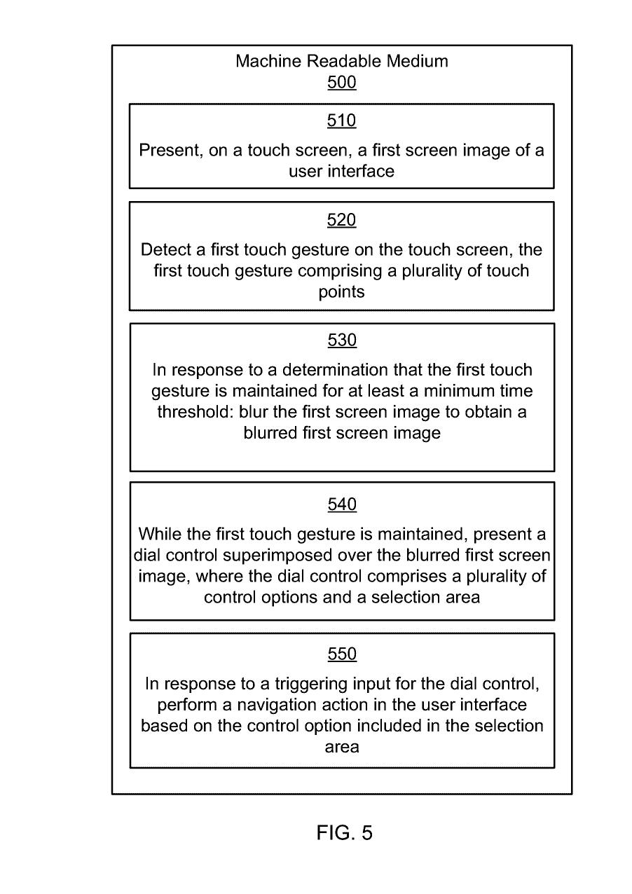

Referring now to FIG. 5, shown is a machine-readable storage medium 500 storing instructions 510-550, in accordance with some implementations. The instructions 510-550 can be executed by any number of processors (e.g., the processor(s) 110 shown in FIG. 1). The instructions 510-550 may correspond generally to the dial control module 140 shown in FIG. 1. The machine-readable storage medium 500 may be any non-transitory computer readable medium, such as an optical, semiconductor, or magnetic storage device.

As shown, instruction 510 may present, on a touch screen, a first screen image of a user interface. Instruction 520 may detect a first touch gesture on the touch screen, the first touch gesture comprising a plurality of touch points. Instruction 530 may, in response to a determination that the first touch gesture is maintained for at least a minimum time threshold, blur the first screen image to obtain a blurred first screen image.

Instruction 540 may, while the first touch gesture is maintained, present a dial control superimposed over the blurred first screen image, where the dial control comprises a plurality of control options and a selection area. Instruction 550 may, in response to a change of a control option included in the selection area of the dial control, perform a navigation action in the user interface based on the control option included in the selection area.

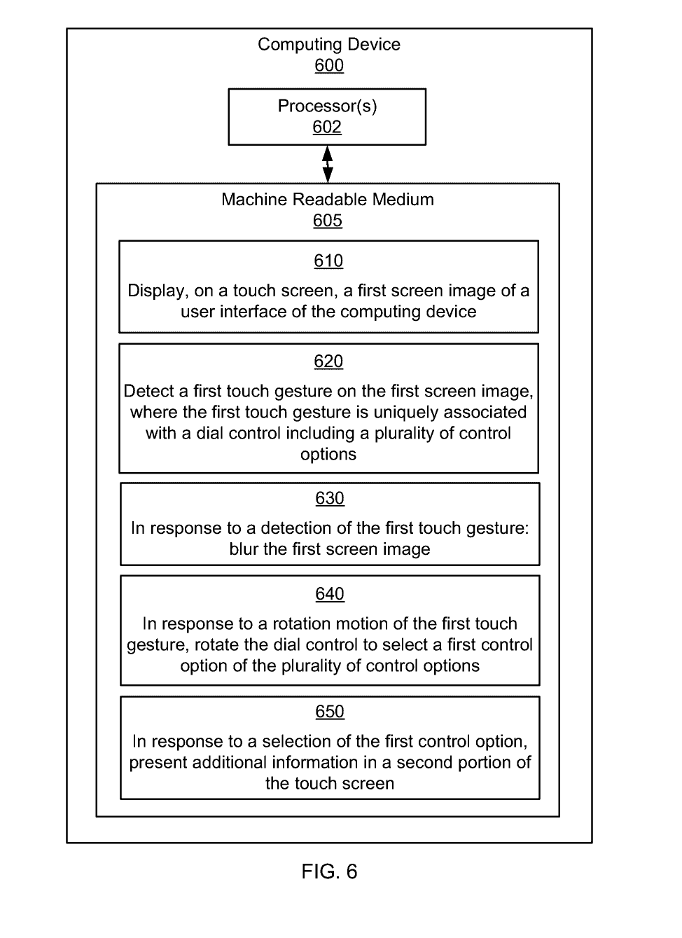

Referring now to FIG. 6, shown is a schematic diagram of an example computing device 600. In some examples, the computing device 600 may correspond generally to the computing device 100 shown in FIG. 1. As shown, the computing device 600 can include a hardware processor(s) 602 and machine-readable storage medium 605. The machine-readable storage medium 605 may store instructions 610-650. The instructions 610-650 can be executed by the hardware processor(s) 602. The instructions 610-650 may correspond generally to the dial control module 140 shown in FIG. 1.

As shown, instruction 610 may display, on a touch screen, a first screen image of a user interface of the computing device. Instruction 620 may detect a first touch gesture on the first screen image, where the first touch gesture is uniquely associated with a dial control including a plurality of control options.

Instruction 630 may, in response to a detection of the first touch gesture, blur the first screen image. Instruction 640 may, in response to a rotation motion of the first touch gesture, rotate the dial control to select a first control option of the plurality of control options. Instruction 650 may, in response to a selection of the first control option, present additional information in a second portion of the touch screen.

In accordance with some implementations, techniques or mechanisms are provided for a dial control for interacting with a user interface on a touch screen. The dial control described herein may enable users to perform control action in a touch screen, while not occupying space on the screen when not in use. Further, in some implementations, focus may be drawn to the dial control by blurring or otherwise obscuring any previous image shown on the screen. In some implementations, a selector feature may enable the user to quickly identify the control option that is currently selected. The dial control may enable the user to rapidly view summary or preview information related to a control option without actually navigating to a different interface screen.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A computing device comprising:
a hardware processor; and
a machine-readable storage medium storing instructions, the instructions executable by the hardware processor to:
display, on a touch screen, a first screen image of a user interface of the computing device;
detect a first touch gesture on the first screen image, wherein the first touch gesture is associated with a dial control including a plurality of control options;
in response to a detection of the first touch gesture:
blur the first screen image;
present the dial control over the first screen image;
in response to a rotation of the first touch gesture, rotate the dial control to select a first control option of the plurality of control options; and
in response to a selection of the first control option, present additional information in a second portion of the touch screen.

2. The computing device of claim 1, the instructions further executable to:
detect a release of the first touch gesture while the selector portion indicates the first control option; and
in response to the release of the first touch gesture, perform a navigation action associated with the first control option.

3. The computing device of claim 2, the instructions further executable to:
in response to the release of the first touch gesture, dismiss the dial control from the touch screen.

4. The computing device of claim 1, wherein the dial control is presented in a first portion of the touch screen, and wherein the additional information is presented in a second portion of the touch screen.

5. The computing device of claim 4, wherein the second portion of the touch screen is separate from the dial control and is not selectable by a user touch.

6. The computing device of claim 1, wherein the dial control includes:
a rotating portion comprising the plurality of control options; and
a selector portion to indicate one of the plurality of control options.

7. The computing device of claim 6, wherein the selector portion of the dial control remains stationary during the rotation motion of the first touch gesture.

8. The computing device of claim 6, wherein the selection of the first control option comprises a change of the one of the plurality of control options that is indicated by the selector portion.

9. A method comprising:
presenting, on a touch screen, a first screen image of a user interface;
detecting a first touch gesture on the first screen image presented on the touch screen, wherein the first touch gesture is to invoke a dial control;
in response to a detection of the first touch gesture:
blurring the first screen image;
presenting a dial control while the first touch gesture is maintained, the dial control comprising a plurality of control options;
receiving a selection of a first control option included in the dial control; and
in response to the selection of the first control option, presenting additional information in an information display area separate from the dial control.

10. The method of claim 9, further comprising:
detecting a release of the first touch gesture while the selector portion indicates the first control option; and
in response to a detection of the release of the first touch gesture, performing a navigation action based on the first control option.

11. The method of claim 9, wherein the dial control includes:
a rotating portion comprising the plurality of control options; and
a selector portion to indicate one of the plurality of control options,
wherein the rotating portion is to rotate in response to a rotation motion of the first touch gesture,
wherein the selector portion is to remain stationary during the rotation motion of the first touch gesture.

12. The method of claim 9, wherein the first touch gesture comprises a first touch point and a second touch point separated by a first distance.

13. The method of claim 12, wherein the dial control comprises an inner circumference and an outer circumference, wherein the inner circumference is defined by the fixed distance between the first touch point and a second touch point of the first touch gesture.

14. The method of claim 13, wherein the plurality of control options are disposed between the inner circumference and the outer circumference of the dial control.

15. An article comprising a machine-readable storage medium storing instructions that upon execution cause a processor to:
present, on a touch screen, a first screen image of a user interface;
detect a first touch gesture on the touch screen, the first touch gesture comprising a plurality of touch points;
in response to a determination that the first touch gesture is maintained for at least a minimum time threshold:
blur the first screen image to obtained a blurred first screen image;
while the first touch gesture is maintained, present a dial control superimposed over the blurred first screen image, wherein the dial control comprises a plurality of control options and a selection area;
in response to a trigging input for the dial control, perform a navigation action in the user interface based on a first control option included in the selection area.

16. The article of claim 15, wherein the instructions further cause the processor to:
in response to a selection of the first control option, present a display of additional information associated with the first control option, wherein the display of additional information is separate from the dial control.

17. The article of claim 15, wherein the navigation action in the user interface comprises a navigation to a second screen image of the user interface.

18. The article of claim 17, wherein the instructions further cause the processor to:
detect a pinch motion during the first touch gesture; and
in response to the pinch motion, dismiss the dial control without performing the navigation action.

19. The article of claim 15, wherein the triggering input comprises a release of the first touch gesture.

20. The article of claim 15, wherein each control option located outside the selection area is blurred based on a distance from the selection area.
